(19) United States
(12) Patent Application Publication
(10) Pub. No.: US 2026/0338327 A1
(43) Pub. Date: Oct. 29, 2026

(54) DEVICE AND METHOD FOR FILLING A PRESSURIZED-GAS TANK

(71) Applicant: L'Air Liquide, Societe Anonyme pour l'Etude et l’Exploitation des Procedes Georges Claude, Paris (FR)

(72) Inventors: Etienne WERLEN, Sassenage (FR); David VEMPAIRE, Sassenage (FR)

(21) Appl. No.: 19/111,487

(22) PCT Filed: Sep. 8, 2023
(86) PCT No.: PCT/EP2023/074773

§ 371 Date: Mar. 13, 2025

(30) Foreign Application Priority Data
Sep. 29, 2022 (FR) FR 2209876

(51) Int. Cl. F17C 13/02; F17C 5/00

(52) U.S. Cl. CPC F17C 13/026; F17C 5/007; F17C 2201/056; F17C 2227/0157

(57) ABSTRACT

A device for filling pressurized-gas tanks includes a refrigeration system for cooling a flow of gas. The refrigeration system comprises a circuit for coolant, with a coolant store having upper and lower parts for hot and cold coolant masses. First and second heat exchangers exchange heat between the coolant and a cold source, and the gas flow, respectively. A bypass portion connects the second duct to the lower part of the store, allowing coolant transfer between the first heat exchanger and the store's lower part, or between the store's lower part and the second heat exchanger, without passing through the first heat exchanger.

### CROSS REFERENCE TO RELATED APPLICATIONS

This application is a § 371 of International PCT Application PCT/EP2023/074773, filed Sep. 8, 2023, which claims the benefit of FR2209876, filed Sep. 29, 2022, both of which are herein incorporated by reference in their entireties.

### FIELD OF THE INVENTION

The invention relates to a device and a method for filling a pressurized-gas tank.

The invention more particularly relates to a device for filling a pressurized-gas tank comprising a distributor intended to supply a tank with pressurized gas from a fluid source, the device comprising a refrigeration system for cooling a flow of gas in the distributor, the refrigeration system comprising a circuit of coolant, such as brine, the coolant circuit comprising the following elements arranged in series in this order:
a coolant reserve, comprising an upper part configured to house a hot mass of the coolant and a lower part configured to house a cold mass of the coolant,
at least one first heat exchanger having an inlet connected to an outlet of the lower part of the reserve by a first duct, the at least one first heat exchanger being configured to exchange heat between the coolant and a cold source, and
a second heat exchanger having an inlet connected to the at least one first heat exchanger by a second duct of the coolant circuit, and an outlet connected to an inlet of the upper part of the reserve by a third duct of the coolant circuit, the second heat exchanger being configured to exchange heat between the coolant and the flow of gas in the distributor.

### BACKGROUND OF THE INVENTION

In a filling device as described above, the intermediate position of the at least one first heat exchanger between the reserve and the second heat exchanger ensures, for a given temperature of the coolant at the outlet of the reserve, a lower temperature at the inlet of the second exchanger. In addition, this intermediate position of the first heat exchanger makes it possible to increase the performance coefficient of the refrigeration unit associated with the filling device.

However, with the device described above, the temperature of the coolant in the reserve and at the outlet of the reserve remains difficult to control. As a result, the temperature of the coolant at the inlet and outlet of the at least one first heat exchanger also remains difficult to control.

### SUMMARY OF THE INVENTION

One aim of the present invention to overcome all or some of the aforementioned drawbacks of the prior art.

In an effort to overcome the deficiencies of the prior art discussed, supra, the device according to a first aspect of the invention, which otherwise corresponds to the generic definition given in the preamble above, is configured such that the coolant circuit comprises a first bypass portion connecting the second duct to the lower part of the reserve in order to allow the selective transfer of coolant from the at least one first heat exchanger to the lower part of the reserve, or from the lower part of the reserve to the second heat exchanger without passing through the at least one first heat exchanger.

By providing a first bypass portion connecting the second duct to the lower part of the reserve, the device according to this first aspect of the invention makes it possible to return at least part of a flow of coolant that has passed through the at least one first heat exchanger to the lower part of the reserve. Returning the coolant to the lower part of the reserve makes it possible to accumulate cold energy therein and to at least partially (re)constitute the cold mass of the coolant, independently of the cold energy requirements in the distributor. The device according to this first aspect of the invention thus promotes and/or makes it possible to maintain a separation in the reserve between the cold mass of the coolant situated in the lower part, and the hot mass of the coolant situated in the upper part.

In addition, partially returning the coolant from the at least one first heat exchanger to the lower part of the reserve has the effect of limiting the flow of coolant transferred to the second heat exchanger from said at least one first heat exchanger. The device according to this first aspect of the invention thus makes it possible to control (reduce) the cooling power supplied to the second heat exchanger from the at least one first heat exchanger.

Furthermore, by providing a first bypass portion connecting the second duct to the lower part of the reserve, the device according to this first aspect of the invention makes it possible to supply the second heat exchanger with a cold mass flow coming directly from the lower part of the reserve. This cold mass flow coming directly from the lower part of the reserve to the second heat exchanger can be in addition to or instead of a flow of coolant cooled after passing through the at least one first heat exchanger to the second heat exchanger. If the at least one first heat exchanger stops, the cold mass flow coming directly from the lower part of the reserve to the second heat exchanger thus ensures continued operation of the filling device.

It should be noted that with two cold mass flows available at the inlet of the second heat exchanger, namely a first flow coming directly from the lower part of the reserve, and a second flow passing through the at least one first heat exchanger, the device according to this first aspect of the invention provides more freedom in the control of the temperature of the coolant at said inlet.

The device according to a second aspect of the invention, which otherwise corresponds to the generic definition given in the preamble above, is essentially characterized in that the coolant circuit comprises a fourth duct connecting an outlet of the upper part of the reserve to the inlet of the at least one first heat exchanger.

By providing a fourth duct in addition to the first duct for connecting the at least one first heat exchanger to the reserve, the device according to this second aspect of the invention offers more freedom for controlling/regulating the quantity of hot mass and the quantity of cold mass contained in the reserve. Likewise, the device according to this second aspect of the invention offers more freedom for controlling/regulating the temperature of the coolant at the inlet and/or at the outlet of the at least one first heat exchanger, due to different possible mixtures between a hot mass flow leaving the upper part of the reserve and a cold mass flow leaving the lower part of the reserve.

In addition, embodiments of the device according to the first and/or second aspect of the invention can comprise one or more of the following features:
the first duct, the second duct, and the third duct of the coolant circuit define a first refrigeration loop of the device;
the fourth duct, the second duct, and the third duct of the coolant circuit define a second refrigeration loop of the device;
the first refrigeration loop and the second refrigeration loop are configured to be operated simultaneously or sequentially;
the first bypass portion connects the first duct to the second duct;
the reserve comprises at least one perforated transverse plate configured to separate the upper and lower parts of the reserve so as to limit transfers of coolant between the hot mass situated in the upper part and the cold mass situated in the lower part;
the coolant circuit comprises a second bypass portion connecting the second duct to the third duct to allow all or some of the coolant at the outlet of the at least one first heat exchanger to return to the reserve without passing through the second heat exchanger;
the coolant circuit comprises a third bypass portion connecting the third duct to the second duct to allow all or some of the coolant at the outlet of the second heat exchanger to return to said second heat exchanger without passing through the reserve or through the at least one first heat exchanger;
the coolant circuit comprises at least one member for circulating the coolant in the coolant circuit and/or at least one member for controlling the temperature of the coolant;
the coolant circuit comprises at least one set of valve(s) configured to control the flows in the circuit, for example one or more three-way valves positioned at a junction between two or more of the ducts and/or bypass portions; and/or
the first bypass portion and the second bypass portion are connected to the second duct by a single set of valves, for example a three-way valve.

The invention also relates to a method for filling a pressurized-gas tank by means of a device according to the first aspect above and any one of the features above or below, wherein a flow of coolant is selectively transferred through the first bypass portion from the at least one first heat exchanger to the lower part of the reserve, or from the lower part of the reserve to the second heat exchanger without passing through the at least one first heat exchanger.

According to possible specific features, the coolant flow transferred from the lower part of the reserve to the second heat exchanger without passing through the at least one first heat exchanger is in addition to or instead of a coolant flow transferred from the at least one first heat exchanger to the second heat exchanger.

According to possible specific features, the method comprises a step of circulating a hot mass flow and a cold mass flow of the coolant from the reserve to the at least one first heat exchanger through the first duct and the fourth duct respectively in order to regulate the temperature of the coolant at the inlet and/or at the outlet of the at least one first heat exchanger.

Finally, the invention relates to a method for filling a pressurized-gas tank by means of a device according to the second aspect above and any one of the features above or below, comprising a step of circulating a hot mass flow and a cold mass flow of the coolant from the reserve to the at least one first heat exchanger through the first duct and the fourth duct respectively in order to regulate the temperature of the coolant at the inlet and/or at the outlet of the at least one first heat exchanger.

The invention can also relate to any alternative device or method comprising any combination of the features above or below within the scope of the claims.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

Further specific features and advantages will become apparent upon reading the description below, which is provided with reference to the following figures, in which:

FIG. 1 shows a schematic, partial view illustrating one possible example of the structure and operation of a device of the invention according to a first embodiment;

FIG. 2 shows a schematic, partial view illustrating one possible example of the structure and operation of a device of the invention according to a second embodiment.

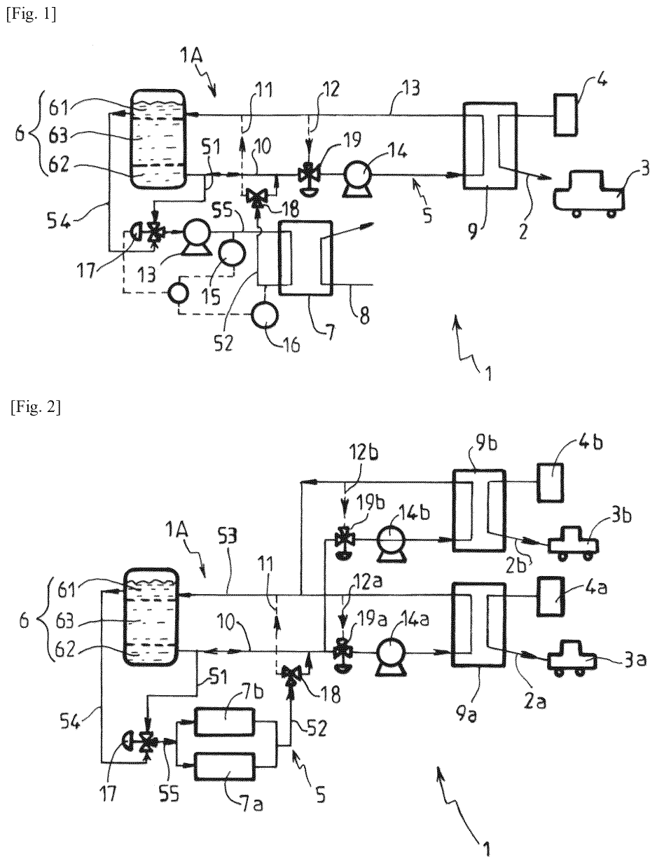

### DETAILED DESCRIPTION OF THE INVENTION

The device 1 for filling pressurized-gas tanks illustrated is, for example, a station for filling pressurized-hydrogen tanks. This device 1 comprises a distributor 2 (a hose equipped with a nozzle, for example) intended to supply a tank 3 with pressurized gas from a fluid source 4 (storage unit(s) and/or compressor(s) and/or the like). The device 1 also comprises a refrigeration system 1A for cooling the flow of gas in the distributor 2.

In particular, the refrigeration system 1A comprises a circuit 5 of coolant, such as brine for example. This circuit 5 comprises a reserve 6 of coolant, at least one first heat exchanger 7 exchanging heat between the coolant and a cold source 8, and at least one second heat exchanger 9 exchanging heat between the coolant flow and a flow of gas in the distributor 2. The reserve 6, the at least one first heat exchanger 7 and the at least one second heat exchanger 9 are positioned in series in a closed loop and define in that order the direction of circulation of the coolant inside the loop.

The reserve 6 comprises an upper part 61 configured to house a relatively hotter mass of the coolant and a lower part 62 configured to house a relatively colder mass of the coolant. The hot mass has a higher mean temperature than the cold mass.

The upper part 61 and the lower part 62 of the reserve 6 each have at least one opening allowing the coolant to flow through the reserve 6. In the example illustrated, the upper part 61 has a separate inlet and outlet for the flow of the hot mass of the coolant through the reserve 6. The lower part 62 has an inlet and an outlet that are formed by a single opening for the flow of the cold mass of the coolant through the reserve 6.

In addition, the reserve 6 can comprise in its volume at least one perforated transverse plate configured to separate the upper part 61 and the lower part 62 of the reserve 6 so as to limit transfers of coolant between the hot mass situated in the upper part 61 and the cold mass situated in the lower part 62. Such a plate promotes a temperature stratification of the coolant in the reserve 6.

In the example illustrated, the reserve 6 comprises two perforated plates that define between them an intermediate part 63 situated between the upper part 61 and the lower part 62. The coolant situated in the intermediate part 63 has a mean temperature between that of the cold mass and that of the hot mass.

The at least one first heat exchanger 7 comprises an inlet that is connected to the outlet of the lower part 62 of the reserve 6 by a first duct 51 of the coolant circuit 5. Advantageously, the at least one first heat exchanger 7 is an evaporator.

Non-limitingly, the cold source 8 associated with the at least one first heat exchanger 7 can comprise a circuit (not illustrated) for a refrigerant, which comprises in a loop: a pump, an evaporator, a refrigerant reserve and then a passage in the at least one first heat exchanger 7. This passage is configured to cool the coolant (here the brine) circulating in the coolant circuit 5.

The second heat exchanger 9 has an inlet connected to an outlet of the first heat exchanger 7 by a second duct 52 of the coolant circuit 5. In addition, the second heat exchanger 9 has an outlet connected to the inlet of the upper part 61 of the reserve 6 by a third duct 53 of the coolant circuit 5.

It should be noted that the second heat exchanger 9 can comprise a conductive mass that can be pre-cooled by the coolant in order to increase the thermal inertia of the cooling (and, if necessary, to provide cooling even without the simultaneous passage of coolant).

The first duct 51, the second duct 52, and the third duct 53 form a first refrigeration loop of the coolant circuit 5.

According to a first aspect of the invention, the coolant circuit 5 comprises a first bypass portion 10 connecting the second duct 52 to the lower part 62 of the reserve 6. The first bypass portion 10 thus allows the selective transfer of coolant from the first heat exchanger 7 to the lower part 62 of the reserve 6, or from the lower part 62 of the reserve 6 to the second heat exchanger 9 without passing through the first heat exchanger 7.

By providing a first bypass portion 10 connecting the second duct 52 to the lower part 62 of the reserve 6, the device 1 according to this first aspect of the invention makes it possible to return at least part of a flow of coolant that has passed through the at least one first heat exchanger 7 to the lower part 62 of the reserve 6.

Returning the coolant to the lower part 62 of the reserve 6 makes it possible to accumulate cold energy therein and to at least partially (re)constitute the cold mass of the coolant, independently of the cold energy requirements in the distributor 2. The upper part 61 of the reserve 6 remains only slightly affected by this return of coolant.

The device 1 according to this first aspect of the invention thus promotes and/or makes it possible to maintain a separation in the reserve 6 between the cold mass of the coolant situated in the lower part 62, and the hot mass of the coolant situated in the upper part 61.

In addition, returning the coolant to the lower part 62 of the reserve 6 has the effect of limiting the flow of coolant transferred to the second heat exchanger 9 from the first heat exchanger 7. The device 1 according to this first aspect of the invention thus makes it possible to control (reduce) the cooling power supplied to the second heat exchanger 9 from the first heat exchanger 7 without losing cold energy.

Furthermore, by providing a first bypass portion 10 connecting the second duct 52 to the lower part 62 of the reserve 6, the device 1 according to this first aspect of the invention makes it possible to supply the second heat exchanger 9 with a cold mass flow coming directly from the lower part 62 of the reserve 6. This cold mass flow coming directly from the lower part 62 of the reserve 6 to the second heat exchanger 9 can be in addition to or instead of a flow of coolant cooled after passing through the first heat exchanger 7 to the second heat exchanger 9. If the first heat exchanger 7 stops, the cold mass flow coming directly from the lower part 62 of the reserve 6 to the second heat exchanger 9 thus ensures continued operation of the filling device 1.

It should be noted that with two cold mass flows available at the inlet of the second heat exchanger 9, namely a first flow coming directly from the lower part 62 of the reserve 6, and a second flow passing through the first heat exchanger 7, the device 1 according to this first aspect of the invention provides more freedom in the control of the temperature of the coolant at said inlet. This is because the two cold mass flows can be at different temperatures, and mixing them in judiciously selected proportions makes it possible to obtain an intermediate temperature at the inlet of the second heat exchanger 9.

Advantageously, the first bypass portion 10 connects the first duct 51 to the second duct 52. This arrangement makes it possible to split a cold mass flow at the outlet of the lower part 62 of the reserve 6 between these two ducts 51, 52.

According to a second aspect of the invention taken in combination with the first aspect above or in isolation, the refrigeration circuit 5 comprises a fourth duct 54 that connects the outlet of the upper part 61 of the reserve 6 to the inlet of the first heat exchanger 7. According to this second aspect of the invention, the coolant circuit 5 thus comprises two ducts 51, 54 that connect the inlet of the first heat exchanger 7 to the outlet of the lower part 62 of the reserve 6 and the outlet of the upper part 61 of the reserve 6 respectively.

By providing a fourth duct 54 in addition to the first duct 51 for connecting the first heat exchanger 7 to the reserve 6, the device 1 according to this second aspect of the invention offers more freedom for controlling/regulating the quantity of hot mass and the quantity of cold mass contained in the reserve 6. Likewise, the device 1 according to this second aspect of the invention offers more freedom for controlling/regulating the temperature of the coolant at the inlet and/or at the outlet of the first heat exchanger 7, due to different possible mixtures between a hot mass flow leaving the upper part 61 of the reserve 6 and a cold mass flow leaving the lower part 62 of the reserve 6.

Advantageously, the fourth duct 54 is connected to the first duct 51. The two ducts 51, 54 have a common segment 55 connected to the inlet of the first heat exchanger 7. The mixing of the cold mass flow passing through the first duct 51 and the hot mass flow passing through the fourth duct 54 takes place in the common segment 55.

The fourth duct 54 forms a second refrigeration loop with the second duct 52 and the third duct 53. The coolant circuit 5 according to this second aspect of the invention thus comprises two refrigeration loops that interact with each other.

It should be noted that the refrigeration loops above can be operated selectively. Each of these loops can then be associated with the first bypass duct 10 to form a filling device according to the spirit of the first aspect of the invention.

Advantageously, the coolant circuit 5 can comprise a second bypass portion 11 connecting the second duct 52 to the third duct 53. This second bypass portion 11 is configured to allow all or some of the coolant at the outlet of the first heat exchanger 7, in particular if it stops, to return to the reserve 6 without passing through the second heat exchanger 9. More specifically, the coolant returns to the upper part 61 of the reserve 6 to form the hot mass. This returned coolant does not reach the lower part 62 of the reserve 6, thus making it possible to maintain a separation between the hot mass and the cold mass therein.

Advantageously, the coolant circuit 5 can comprise a third bypass portion 12 connecting the third duct 53 to the second duct 52. This third bypass portion 12 is configured to allow all or some of the coolant at the outlet of the second heat exchanger 9 to return to said second heat exchanger 9 without passing through the reserve 6 or through the first heat exchanger 7.

Advantageously, the coolant circuit 5 preferably comprises at least one member 13, 14 for circulating the coolant in the coolant circuit 5 and/or at least one member 15, 16 for controlling the temperature of the coolant. The at least one member 13, 14 for circulating the coolant in the circuit 5 can be a pump, for example. In the example illustrated, a first circulation member 13 and a first temperature-control member 15 are positioned in the segment 55 common to the ducts 51, 54.

Advantageously, the coolant circuit 5 preferably comprises at least one set of valve(s) 17, 18, 19 configured to control the flows in the circuit 5. The at least one set of valve(s) 17, 18, 19 consists for example of one or more three-way valves positioned at a junction between two or more of the ducts 51, 52, 53, 54 and/or the bypass portions 10, 11, 12.

In the example illustrated, a first set of valves 17, for example a three-way valve, connects the first duct 51, the fourth duct 54, and their common segment 55. A second set of valves 18, for example a three-way valve, connects the first bypass portion 10 and the second bypass portion 11 to the second duct 52.

In one embodiment illustrated in FIG. 2, the device 1 can comprise a plurality of distributors (here two distributors 2a, 2b) intended to supply separate tanks 3a, 3b, simultaneously or otherwise. To this end, the device 1 comprises a plurality of second heat exchangers (here two heat exchangers 9a, 9b) each associated with a distributor 2a, 2b. The second heat exchangers are positioned in parallel in the circuit 5. In the example illustrated, the device 1 can also comprise a plurality of first heat exchangers 7a, 7b positioned in parallel in the circuit 5.

In order to incorporate the different first heat exchangers 7a, 7b into the circuit 5, the common segment 55 has a first set of parallel branches respectively passing through the different first heat exchangers 7a, 7b.

In addition, in order to incorporate the different second heat exchangers 9a, 9b into the circuit 5, the second duct 52 has a second set of parallel branches (here two branches) each connecting an inlet of a second heat exchanger 9a, 9b to an outlet of the set formed by the first heat exchangers 7a, 7b. Likewise, the third duct 53 has a third set of parallel branches (here two branches) each connecting an outlet of a second heat exchanger 9a, 9b to the inlet of the reserve 6.

In other words, in this second embodiment, the second duct 52 and the third duct 53 together form a series of pairs of parallel branches respectively passing through the second heat exchangers 9a, 9b. Each pair of this series comprises a branch belonging to the second duct 52 and a branch belonging to the third duct 53.

The device 1 can comprise a bypass portion 12a, 12b between a branch of the second duct 52 and a branch of the third duct 53 that pass through a given second exchanger 9a, 9b. This bypass portion 12a, 12b is configured to allow all or some of the coolant at the outlet of the second exchanger 9 in question to return to said second exchanger without passing through the reserve 6 or through the set formed by the first heat exchangers 7a, 7b. Alternatively, this bypass portion 12a, 12b can be configured to allow all or some of the coolant at the outlet of the set formed by the first heat exchangers 7a, 7b to return to the reserve 6 without passing through the second exchanger 9 in question.

As in the first embodiment, here again the circuit 5 comprises a set of members 14a, 14b for circulating fluid and a set of valve(s) 19a, 19b configured to control the flows in the circuit 5. In particular, a splitter valve or valves (not shown) can be provided to control the flow of coolant towards the different second heat exchangers 9a, 9b.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-15. (canceled)

16. A device for filling pressurized-gas tanks comprising:
a distributor configured to supply a tank with pressurized gas from a fluid source,
a refrigeration system configured to cool a flow of gas in the distributor, the refrigeration system comprising a circuit of coolant, the circuit comprising the following elements arranged in series in this order:
a coolant reserve, comprising an upper part configured to house a hot mass of the coolant and a lower part configured to house a cold mass of the coolant,
at least one first heat exchanger having an inlet connected to an outlet of the lower part of the reserve by a first duct, the at least one first heat exchanger being configured to exchange heat between the coolant and a cold source, and
a second heat exchanger having an inlet connected to the first heat exchanger by a second duct of the coolant circuit, and an outlet connected to an inlet of the upper part of the reserve by a third duct of the coolant circuit, the second heat exchanger being configured to exchange heat between the coolant and the flow of gas in the distributor,
wherein the circuit comprises a first bypass portion connecting the second duct to the lower part of the reserve such that the first bypass portion is configured to allow the selective transfer of coolant from the at least one first heat exchanger to the lower part of the reserve, or from the lower part of the reserve to the second heat exchanger without passing through the at least one first heat exchanger.

17. The device as claimed in claim 16, wherein the inlet of the at least one first heat exchanger is also connected to an outlet of the upper part of the reserve by a fourth duct of the coolant circuit.

18. The device as claimed in claim 16, wherein the first duct, the second duct, and the third duct of the coolant circuit define a first refrigeration loop of the device.

19. The device as claimed in claim 17, wherein the fourth duct, the second duct, and the third duct of the coolant circuit define a second refrigeration loop of the device.

20. The device as claimed in claim 19, wherein the first refrigeration loop and the second refrigeration loop are configured to be operated simultaneously or sequentially.

21. The device as claimed in claim 16, wherein the first bypass portion connects the first duct to the second duct.

22. The device as claimed in claim 16, wherein the reserve comprises at least one perforated transverse plate configured to separate the upper and lower parts of the reserve so as to limit transfers of coolant between the hot mass situated in the upper part and the cold mass situated in the lower part.

23. The device as claimed in claim 16, wherein the coolant circuit comprises a second bypass portion connecting the second duct to the third duct to allow all or some of the coolant at the outlet of the at least one first heat exchanger to return to the reserve without passing through the second heat exchanger.

24. The device as claimed in claim 16, wherein the coolant circuit comprises a third bypass portion connecting the third duct to the second duct to allow all or some of the coolant at the outlet of the second heat exchanger to return to said second exchanger without passing through the reserve or through the at least one first heat exchanger.

25. The device as claimed in claim 16, wherein the coolant circuit preferably comprises at least one member for circulating the coolant in the coolant circuit and/or at least one member for controlling the temperature of the coolant.

26. The device as claimed in claim 25, wherein the coolant circuit comprises at least one set of valve(s) configured to control the flows in the circuit, for example one or more three-way valves positioned at a junction between two or more of the ducts and/or bypass portions.

27. The device as claimed in claim 26, wherein the first bypass portion and the second bypass portion are connected to the second duct by a single set of valves, for example a three-way valve.

28. A method for filling a pressurized-gas tank by means of a device; the method comprising the steps of:
providing the device as claimed in claim 16;
selectively transferring a flow of coolant through the first bypass portion from the at least one first heat exchanger to the lower part of the reserve, or from the lower part of the reserve to the second heat exchanger without passing through the at least one first heat exchanger.

29. The method as claimed in claim 28, wherein the coolant flow transferred from the lower part of the reserve to the second heat exchanger without passing through the at least one first heat exchanger is in addition to or instead of a coolant flow transferred from the at least one first heat exchanger to the second heat exchanger.

30. The method as claimed in claim 29, comprising a step of circulating a hot mass flow and a cold mass flow of the coolant from the reserve to the at least one first heat exchanger through the first duct and the fourth duct respectively in order to regulate the temperature of the coolant at the inlet and/or at the outlet of the at least one first heat exchanger.
